(19) United States
(12) Patent Application Publication
(10) Pub. No.: US 2009/0095056 A1
(43) Pub. Date: Apr. 16, 2009

(54) Device and method for determining evaporation rate potential

(76) Inventors: Charles Dewald, III, Morristown, TN (US); Jerry Blaylock, Morristown, TN (US)

Correspondence Address: CLARK & BRODY, 1090 VERMONT AVENUE, NW, SUITE 250, WASHINGTON, DC, 20005, US

(21) Appl. No.: 12/153,179

(22) Filed: May 14, 2008

Related U.S. Application Data
(60) Provisional application No. 60/924,399, filed on May 14, 2007.

(51) Int. Cl. G01N 25/02

(52) U.S. Cl. 73/61.77

(57) ABSTRACT

An evaporation rate potential is determined to show the feasibility of evaporation within an environment. The environment includes air and a material, such as wood or other building material. The temperature and vapor pressure differences determine the flow of sensible and latent energy from the air to the material, and vice versa. Using these values, the evaporation rate potential is determined for different conditions within the environment so that evaporation and drying can be improved.

### FIELD OF THE INVENTION

The present invention relates to facilitating the removal of water and moisture from an environment by determining an evaporation rate potential. More particularly, the present invention relates to determining the evaporation rate potential for a system and using this information to improve drying and moisture removal within the environment.

### DISCUSSION OF THE RELATED ART

Water mitigation professionals and drying services seek to remove water from a structure or materials. After a disaster, flood and other like conditions, water disturbs the normal equilibrium within a system that result in changes to parts of that system. Water is absorbed into the air from materials or the materials draw moisture from the air. This excess water needs to be removed from the system to bring it back to normal conditions. Removal of water, however, can become a complicated issue dependent on a variety of factors.

Two forms of water removal are used in most situations. One form of removal is physically removing the water, such as extraction. This form is easiest and requires the least amount of energy. One wants to physically remove as much water as possible at the beginning of a job. The other form of water removal is evaporation of the remaining water within materials. This form of water removal can be more time consuming than the other.

Evaporation can be modeled or determined for certain conditions to understand drying conditions for a system. A method known as evaporation potential focuses on determining the exact rate of evaporation from a material surface. Another method focuses on the ambient air conditions surrounding the material and the correlation to the equilibrium moisture content of the material subject to be dried. Both methods are described in greater detail below.

With regard to evaporation potential (EP), this value simply represents the vapor pressure of the wet surface(s) minus the vapor pressure of the air at the wet surface(s), or, in other words, the difference between vapor pressures. The EP method establishes an idea of the exact rate of evaporation from the surface of a material. The following formula may be used:

E=f_{d}(u)(Eₛ−Eₐ), where [Equation 1]

E represents the rate of evaporation,

F_{d} (u) represents a function of the mean wind speed, or u,

Eₛ represents the saturation vapor pressure for the temperature of the water surface, and

Eₐ represents vapor pressure in the air.

The evaporation potential method dropped the function of the wind speed and used the saturation vapor pressure minus the actual vapor pressure in the air. This difference was applied to the materials to form an idea of an evaporation rate. For vapor pressure, one determines this factor for water by finding its surface temperature. For example, the vapor pressure was determined by measuring the temperature of the water on a surface and calling it “saturated” because it was pure water. Thus, one may calculate the vapor pressure by taking the temperature of the water and assuming the relative humidity at that temperature to be 100%.

Problems occur with the evaporation potential method at this point with regard to analyzing water-logged materials. The evaporation potential method assumes that the surface temperature of a wet structure is usable to determine the saturation vapor pressure of the material. This assumption, however, is flawed because even a really wet or damp material is distinguishable from pure water. The surface temperature may serve as an approximation for the vapor pressure of the material when considering the free water sitting the pores of or in pools on the material, but a bad assumption when considering water within the material.

For example, two different pieces of wood may be considered at a temperature of 80 degrees (°) F. The first piece may include a moisture content of 30% while the second piece of wood may include a moisture content of 15%. The evaporation potential formula may conclude that the evaporation rate is the same for both pieces of wood even though one piece has twice the amount of water to evaporate. Thus, the conclusion would be incorrect.

Another shortcoming to the evaporation potential process is that this model poorly predicts drying performance due to the assumption that the surface temperature approximates the temperature throughout the wet or Clamp material. This assumption does not accurately represent the different temperature gradients in the material. For example, one might see a 15 to 20° F. temperature difference from the bottom side of the material to the top.

Another shortcoming of the evaporation potential process is that it does not provide much, if any, information to restorers. The evaporation potential only gives a single value for measurements taken at that given time. It does not provide information on how to make improvements in a drying process. In fact, the information provided by the evaporation potential just reflects the actual moisture content within the materials for the specific time the measurements are taken. For example, one could determine a starting moisture content of 30% on a first day, and then determine a drop to 28% on the next. These values do not help in determining what one needs to better reduce the moisture content for the second day to improve the drying process.

The evaporation potential process does show that the higher the temperature of the material, then the better the conditions for drying it. Further, the temperature of the material will increase as a function of the rate at which it evaporates its water. The rate of water removal from the material is a function of the ambient conditions around the material because these conditions are the direct medium for energy transfer. For example, air can be considered the “ambient conditions” in contact with the material. The higher the temperature of the air, then the more energy can be transferred to the material.

The evaporation potential process, however, fails to provide answers for several important questions for improving the drying process. It does not consider those conditions that will create the fastest rate of energy transfer between the materials and the air. The evaporation potential process does not provide these conditions or information on increasing the rate of energy transfer.

Another process for predicting drying performance focuses on the equilibrium moisture content method produced by the U.S. Department of Agriculture (USDA). The USDA provides equilibrium moisture content (EMC) readings associated with virtually any ambient condition available. For example, a condition having 70° F. and 45% relative humidity results in an EMC of 8.5%. This EMC means that if wood was exposed to the conditions cited above, then the wood would eventually achieve an equilibrium moisture content of 8.5%. The wood will not go lower than this value.

Continuing the above example, a condition of 110 degrees F. and 50% relative humidity results in an equilibrium moisture content of 8.4%. These results might lead someone to make comparisons in the drying performances of different ambient conditions. The comparison, however, has at least one flaw, which is that the above process does not factor time into the EMC results. Time is an extremely important factor in a drying process.

Following the EMC process described above, the two conditions set forth in the example would result in approximately same drying conditions of about 8.5%. This may or may not be true. It is unclear which condition would take longer to dry the material out using EMC. Thus, neither method discussed above provides reliable or useful information on drying conditions and how to improve them.

### SUMMARY OF THE INVENTION

The disclosed embodiments of the present invention provide an evaluation tool and processes for comparing the evaporation potential of any two sets of ambient air conditions, such as temperature, relative humidity and the like. The disclosed embodiments then may use the comparisons to improve drying conditions within an environment. The disclosed embodiments may provide a definitive understanding of ambient air conditions that will result in more efficiently drying out water damaged or soaked material or structure. The disclosed embodiments also show how to achieve improved ambient conditions for evaporation regardless of outside conditions.

The present invention relates to methods, devices and systems for improving drying efficiency. The disclosed embodiments of the present invention, for example, improve conditions for evaporation within a system for better drying. Evaporation describes a change of state in water from liquid form to vapor form. For liquid water to convert to water vapor, energy must be added to increase the molecular movement to break the attractive forces of the bonds that exists between neighboring water molecules. The higher the temperature, the more energy is available to break the bonds between the water molecules. The increase in energy to break the bonds may come from a variety of sources.

Evaporation can be impacted by several conditions, but the most important factors are temperature, grains per pound and cubic feet per minute. Temperature may refer to the amount of energy supplied to wet material. Grains per pound may refer to the vapor pressure of the air in contact with the wet material. Cubic feet per minute (CFM) may refer to the amount of air flow supplied directly to the wet material.

Thus, an efficient drying system according to the disclosed embodiments should have high temperatures, dry air and a high CFM air flow. For high temperatures, an efficient drying process supplies more energy in the form of heat. For dry air, an efficient drying process keeps lower vapor pressure by removing water from the air. Obviously, for a high CFM air flow, an increased air flow is desired.

With regard to water loss, the energy used for evaporation by water in a liquid form is provided by the energy stored in the air of a system. The air must come in contact with the water held in materials for this energy transfer to take place. The energy that the water absorbs is used to increase the motion of the molecules to break the bonds. Thus, evaporation takes place as energy in the water within the material increases.

Knowing the fact that the temperature of the air is a direct measurement of its energy content, the higher the inside air temperature, the more energy available for evaporation. Thus, with all other factors constant (i.e., grains per pound and CFM), for example, one hundred (100) degrees Fahrenheit has more evaporation energy than 70, 80 or 90 degrees.

On average, the energy necessary for one pound of liquid water to be converted to water vapor is 1061 British thermal units (Btus). This value may increase or decrease based on the barometric and vapor pressure differentials between the liquid and the air. Barometric pressure may impose a greater influence on the actual Btu/lb value, but this factor may not be controllable. Vapor pressure, however, may be controlled as disclosed below.

The disclosed embodiments provide an improved methodology that factors in time along with other factors to provide an idea of the actual drying performance of any set of given conditions. The easiest conditions to control and measure regarding water loss are the ambient conditions. Next to air movement, the ambient conditions surrounding the wet material may have the single largest impact on the drying rate of the material. The disclosed embodiments provide a way effectively quantify the value of a set of given ambient conditions in the drying process. The disclosed embodiments unite the processes of lowering the grains of moisture and raising the temperature as high as possible to improve drying performance.

Thus, according to the disclosed embodiments, a method for determining an evaporation rate potential within an environment is disclosed. The method includes determining a sensible energy value. The method also includes determining a latent energy value. The sensible energy value and the latent energy value comprise a total enthalpy value. The method also includes determining a potential rate for evaporation using a square value of the sensible energy value divided by the latent energy value.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates an environment for drying a material according to the disclosed embodiments.

FIG. 2 illustrates a flowchart for determining the evaporation rate potential according to the disclosed embodiments.

FIG. 3 illustrates a flowchart for determining the evaporation rate potential between different conditions according to the disclosed embodiments.

FIG. 4 illustrates a block diagram of a device to determine evaporation rate potential according to the disclosed embodiments.

### DETAILED DESCRIPTION OF THE PREFERRED EMBODIMENTS

Aspects of the invention are disclosed in the accompanying description. Alternate embodiments of the present invention and their equivalents are described without parting from the spirit or scope of the present invention. It should be noted that like elements disclosed below are indicated by like reference numbers in the drawings.

As disclosed above, the higher the temperature value, the more energy transferred to the liquid water for evaporation. The lower the vapor pressure, the less energy it takes to evaporate the same pound of water. Thus, if a drying system is always applying the same amount of energy/hr to be used for evaporation, the vapor pressure or grains of moisture then becomes the controlling factor for the evaporation rate. A lower vapor pressure results in faster drying.

Thus, the disclosed embodiments of the present invention achieve efficient evaporation conditions by quantifying the evaporation process or rate of evaporation. Further, the disclosed embodiments provide value to the methods used to evaluate the drying process.

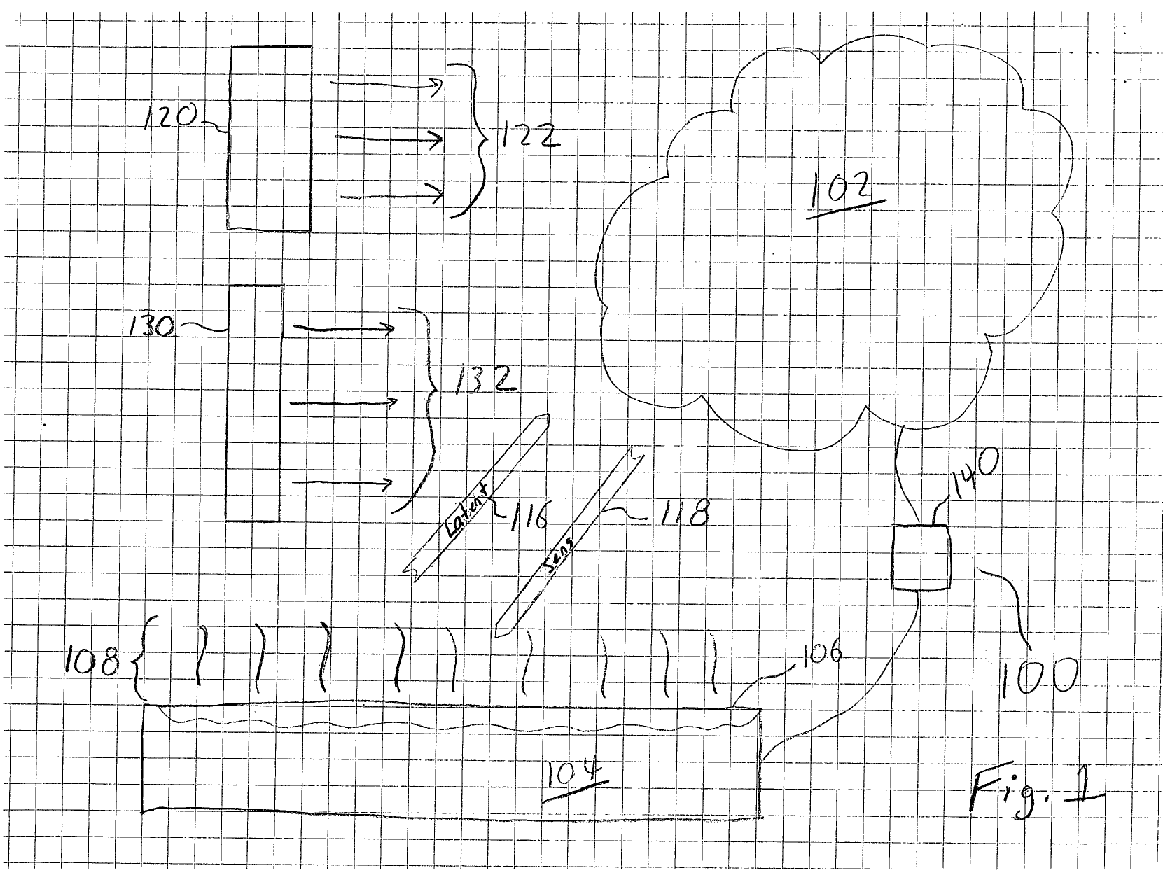

FIG. 1 depicts an environment 100 for drying material 104 according to the disclosed embodiments. Environment 100 includes material 104 along with ambient air 102. Air 102 surrounds material 104 as much as possible. Preferably, air 102 comes into contact with material 104 on all its surfaces except those touching other objects. Air 102 and material 104 also may be referred to as “systems” within environment 100.

Material 104 may be any item, article, material and the like that can get wet and, preferably, absorb water. More preferably, material 104 is wood or other building material. Material 104 also may be part of a structure, such as a house or building. Material 104 may connect with other materials. Material 104 shows water 106 on it. Water 106 is in liquid form. Alternatively, water 106 may be any liquid capable of soaking material 104, but is referred to as water hereinafter for simplicity. For example, water 106 may refer to any liquid, such as coffee, having water in it. Water 106 may or may not soak entirely through material 104. Thus, parts of material 104 may be dry, or devoid of water 106, while other parts of material 104 are wet.

When water 106 evaporates, it changes to vapor 108, which is a gas. As disclosed above, evaporation is an energy transfer process that achieves equilibrium between material 104 and air 102. The change in water 106 to vapor 108 occurs to efficiently achieve equilibrium between the two systems in terms of both their vapor pressures, or latent energy, and their temperatures, or sensible energy.

Prior to water loss within environment 100, both air 102 (system 1) and material 104 (system 2) are in equilibrium with each other with regard to vapor pressures and temperatures. The vapor pressures also may be referred to as latent energy values and the temperatures as sensible energy values. When a variation happens away from the equalized state, air 102 and material 104 will transfer energy accordingly. The transfer occurs from the highest to lowest total energy values until equilibrium is reached.

The total net energy gradient that is caused between any two systems in an unequal state includes two sub-gradients that also flow from highest to lowest in their sub-gradient directions. The sub-gradient directions can be in the direction of the total net energy gradient or in the opposite direction. The two sub-gradients shown in FIG. 1 are latent sub-gradient 116, which represents the high vapor pressure moving to a low vapor pressure and sensible sub-gradient 118, which represents the high temperature moving to a low temperature. Latent sub-gradient 116 and sensible sub-gradient 118 are the total net energy of between systems, or, in this instance, air 102 and material 104.

When water 106 changes to vapor 108, the equilibrium state that once existed between air 102 and material 104 is thrown out of balance. Water 106 adds more energy to environment 100. The net total energy flow is going to move from material 104 to air 102.

Referring to sub-gradients 116 and 118, the higher latent energy of water 106 within material 104 is going to flow from material 104 to air 102. Thus, latent sub-gradient 116 flows from material 104 to air 102. In other words, the higher vapor pressure of material 104 seeks to equalize with the low vapor pressure of air 102. There is higher sensible energy within air 102 than material 104 due to the cooling of the evaporation process. Thus, sensible energy is going to flow from air 102 to material 104 as sensible sub-gradient 118, which is in the opposite direction of the net total energy gradient. The difference in terms of the latent energy values between material 104 and air 102 is greater than the difference between the sensible energy values between air 102 and material 104. These differences provide a net total energy gradient flowing from material 104 to air 102.

As disclosed above, the change of state from water 106 to vapor 108 is performed to efficiently achieve equilibrium between two systems in terms of their vapor pressures and temperatures. Because evaporation is an energy transfer process, the disclosed embodiments use data or terms that provide an indication of the energy value associated with air 102 and material 104 on water loss. This term may be referred to as enthalpy (h). The enthalpy is a measurement of the total stored energy of air 102 and may be measured in Btu/lb. Enthalpy denotes how much total energy that each pound of air contains. The enthalpy may include the latent and sensible components, or sub-gradients, disclosed above.

As disclosed above, one component, shown as sub-gradient 118, represents the sensible energy portion of the enthalpy and deals with the temperature of air 102. The sensible portion of the enthalpy measures the energy to raise the temperature of air 102 from 0° F. to its current temperature. Alternatively, the energy could be from 32° F. to its current temperature, or 0° Celsius. In other words, the sensible energy shown by sensible sub-gradient 118 is the energy available to break the molecular bonds for evaporation of water 106.

The other component, shown as latent sub-gradient 116, represents the latent energy portion of the enthalpy and deals with the actual water in air 102. This value would be the grains per lb, or the vapor pressure, and not the relative humidity. The latent portion of the enthalpy measures the energy it takes to evaporate the amount of water, in grain/lb or vapor pressure, in air 102 under set conditions. For example, the set conditions may related to conditions in a room under normal conditions in a house or dwelling.

The sensible energy portion and the latent energy portion may be represented using the formulas disclosed below. The end results of the formulas are sensible energy and latent energy values in Btu/lb. The portions also may be combined to determine the total enthalpy (h) for environment 100.

The sensible energy portion may be shown as

Sensible Energy Portion=(0.24 Btu/lb-F.°)(T)+(W)(0.45 Btu/lb-F.°). [Equation 2]

The latent energy portion may be shown as

Latent Energy Portion=(W)(1,061). [Equation 3]

Thus, the total enthalpy (h) may be shown as

(h)=(0.24 Btu/lb-F.°)(T)+(W)((1061+(0.45 Btu/lb-F.°)(T)), or Sensible Energy Portion+Latent Energy Portion. [Equation 4]

In the equations disclosed above, the value of 0.24 Btu/lb represents the number of Btus to either raise or lower the temperature of 1 lb of air by 1° F. The value of 0.45 Btu/lb represents the number of Btus to either raise or lower the temperature of 1 lb of water vapor by 1° F. T represents the temperature of air in degrees F. W represents the humidity ratio for a lb of water vapor/lb for air, where 7000 grains/lb of air. Thus, W is determined by dividing the grains per pound (gpp) by 7000. The number 1061 represents the average number of Btus desired to evaporate or condense 1 lb of water.

Whenever a variation occurs from the equalized state, air 102 and material 104 (system 1 and system 2) will transfer energy accordingly in the forms of latent sub-gradient 116 and sensible sub-gradient 118 from the highest to lowest energy values until equilibrium is reached. To achieve equilibrium quickly between any two systems, such as air 102 and material 104, environment 100 seeks to provide air 102 with the highest temperature, or sensible energy value, and the lowest vapor pressure, or latent energy values. The disclosed embodiments help provide information and determinations to facilitate getting air 102 to these conditions so as to help dry out material 104.

Equation 5 below defines this correlation in terms of an evaporation rate potential (ERP), or

ERP=(S²/L*k)×1000, [Equation 5]

where S represents the sensible energy portion of the enthalpy in Btu/lb. L represents the latent energy portion of the enthalpy, also in Btu/lb. The term “k” represents the latent heat of vaporization, or 1061 Btu/lb. The value of 1000 merely represents a constant to provide larger values for the ERP number. The ratios do not change by using this constant. Other values for the constant may include 100 or 10,000.

The S/L portion of Equation 5 provides an indication of the composition of the energy of air 102, such as which condition most impacts evaporation. In this instance, sensible energy provides a greater impact than latent energy. Thus, with all other factors being equal, the higher the ratio of sensible energy to the latent energy, then the better the condition for evaporation. In other words, the higher the ratio, the greater the gradients in the sensible and latent values of air 102 and in material 104 in the direction that will cause liquid, such as water, to want to move from material 104 to air 102 in the shortest time period.

In Equation 5, the term S/L shows the breakdown of the enthalpy (h) and describes the usefulness of a condition for evaporation. In the examples provided below, the usefulness of the ERP determination is shown when compared to just using the S/L ratio. Example 1 has the following conditions within environment 100: 80° F. with 45% relative humidity (RH) which results in 70 grains per part and a total enthalpy value of 30 Btu/lb, where the sensible portion has a value of 20 Btu/lb and the latent portion has a value of 10 Btu/lb. Using these values and the equations disclosed above, example 1 results in an S/L ratio value of 2 and a total ERP value of 34.7.

Example 2 has the following conditions within environment 100: 100° F. with 14% RH which results in 30 grains per part and a total enthalpy value of 30 Btu/lb. In example 2, the sensible portion has a value of 24 Btu/lb and the latent portion has a value of 6 Btu/lb. Thus, example 2 shows conditions where the temperature is higher and vapor pressure is lower than example 1. Using the values for these conditions, example 2 results in an S/L ratio value of 4 and a total ERP value of 92.4. The inclusion of the second sensible variable in Equation 5 provides the difference in magnitude from a straight S/L ratio.

The reason for the second S, or sensible energy value, variable is explained as follows. Similar S/L ratios can be had at multiple temperatures. Evaporation is a process that is determined by the temperature or energy available within environment 100. Thus, the higher the temperature of air 102, then the faster the evaporation rate. Thus, conditions with similar S/L ratios can be compared further by examining the same temperature having different conditions. Thus, the higher temperatures would seem more advantageous for drying even if the S/L ratios are identical. For instance, if one set of conditions includes a temperature value of 60° F. and another set of conditions includes a temperature value of 90° F., then the higher temperature value would provide a better potential for evaporation because it has a higher total energy value than the lower temperature's conditions.

The act of raising the temperature, however, is not always feasible and other variables are considered. To account for this, the disclosed embodiments set forth an ERP determination that “squares” the sensible portion of the Equation 5. This action accounts for the variation of the two sets of conditions by showing the second set of conditions with a higher ERP value. For example, looking at the conditions discussed above, the set of conditions having a temperature of 60° F. and 40% RH having 30 gpp has an ERP value of 43.0 but an S/L ratio value of 3.1. The other set of conditions includes a temperature of 90° F. and 22% RH having 46 gpp also has an S/L ratio value of 3.1 but an ERP value of 65.0. Thus, the second set of conditions obviously provides the better drying conditions as shown by the variations between the ERP values. The Btu/lb value was added to make Equation 5 unit-less.

The full formula may be shown as

(((0.24 Btu/lb-F.°)(T)+W(0.45 Btu/lb-F.°))*((0.24 Btu/lb-F.°)+W(0.45 Btu/lb-F.°))*1000)/((W)(1061)*1061). [Equation 6]

Thus, different conditions will result in different ERP numbers. The higher the ERP number, then the better the conditions for drying material 104. To improve conditions for drying, heater 120 may be activated to provide heated air 122 to environment 100. Thus, the temperature of air 102 will increase the ERP value. Further, dehumidifier 130 removes water from air 102 to provide low vapor pressure air 132 to environment 100. A desiccant also works well in removing water molecules from air 102. After these actions are taken, the disclosed embodiments may perform ERP determinations to see if the evaporation potential improved.

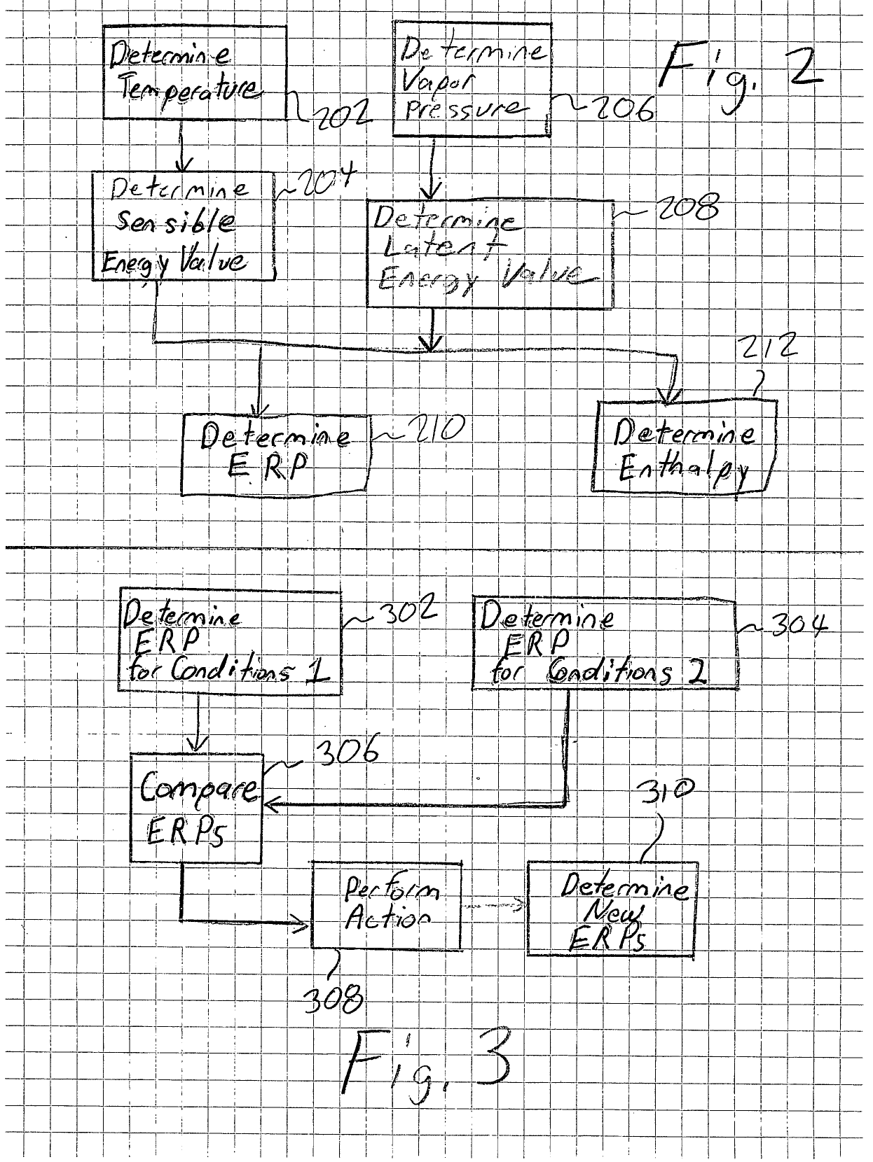

FIG. 2 depicts a flowchart of determining an ERP number for an environment having air and a material according to the disclosed embodiments. Step 202 executes by determining the temperature of air 102, as disclosed above. Step 204 executes by determining the sensible energy value, or S, using Equation 3, disclosed above. Referring back to FIG. 1, the sensible energy flow is shown by sub-gradient 118.

Step 206 executes by determining the vapor pressure value of air 102. Step 208 executes by determining the latent energy value, or L, using Equation 4, disclosed above. The latent energy flow is shown by sub-gradient 116 in FIG. 1. Using these values, step 210 executes by determining an ERP number using Equation 5, disclosed above. The ERP number represents the potential rate for evaporation and, as shown in Equation 5, is in relation to the square value of the sensible energy value divided by the latent energy value. Step 212 executes by determining the total enthalpy for air 102 within environment 100 using Equation 4, as disclosed above. This enthalpy value may be used with the ERP value to provide a better understanding of the drying conditions.

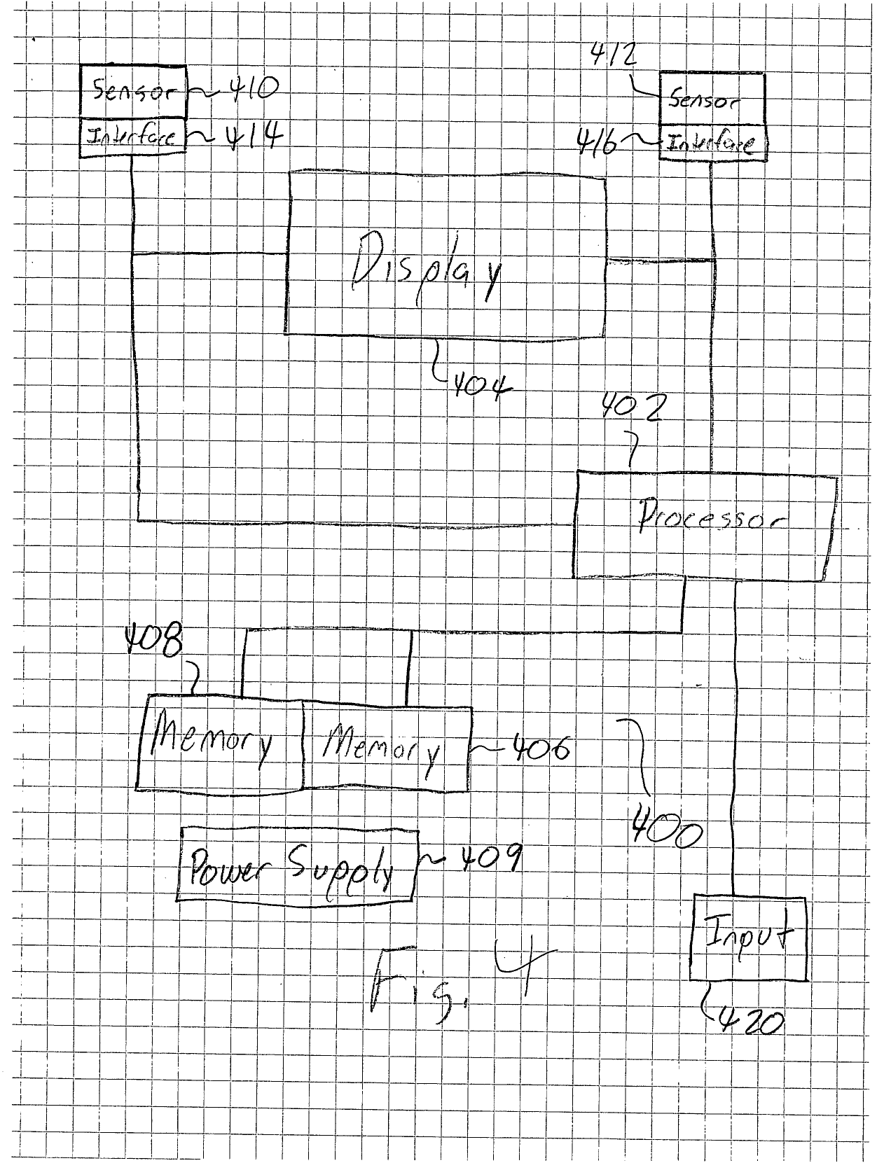

FIG. 3 depicts a flowchart for determining the evaporation rate potential between different conditions according to the disclosed embodiments. This process is desirable when comparing the impact changes in the temperature or vapor pressure might have on an environment for drying. Step 302 executes by determining an ERP value for a first set of conditions. For example, the first set of conditions may include a temperature of 120° F., a relative humidity of 14% and a vapor pressure of 70 gpp. These conditions result in an ERP value of 75.0, using Equation 5 disclosed above.

Step 304 executes by determining an ERP value for a second set of conditions, using the same environment. Using the example above, the second set of conditions may include a temperature of 90° F., a relative humidity of 15% and a vapor pressure of 30 gpp. These conditions result in a second ERP value of 95.0. Although the second set of conditions include a lower temperature and a slightly higher relative humidity than the first set, the ERP value indicates those conditions are better for drying.

Step 306 executes by comparing the ERP values to determine which set of conditions are better for drying a material, such as material 104. Using the above example, step 306 would determine that the second set of conditions result in better drying conditions. Step 306 also may indicate this result to a user via a display, message, audio and the like. Further, step 306 may analyze several sets of conditions to provide the best one according to the highest ERP value.

Step 308 executes by performing an action, such as raising the temperature or removing water from air 102. One may increase the temperature by a certain number of degrees or decrease the grains/lb of water in the air. The disclosed embodiments may even indicate what action needs to be taken to fit a desired ERP value. Using the above example, if removing water grains from the air is cheaper than raising the temperature, the disclosed embodiments may recommend the use of a desiccant within environment 100 as opposed to just heating the air. As energy prices soar, such alternatives become more important.

Step 310 executes by determining additional ERP values for new conditions to determine if any of the actions taken in step 308 worked. Thus, step 310 may simply loop back to steps 302 and 304 to determine new ERP values, or may go to steps 202 and 206 to determine a single ERP value based on the proposed action. One may use this single ERP value to compare against the desired one determined in step 306.

Referring back to the example given above, a comparison of the first and second sets of conditions indicates that the second set will dry about 27% faster than the first set, despite the first set having a higher temperature value. Thus, a proposed action may be to allow the temperature to reduce to a manageable 90° F. in drying out a room with materials but reducing the vapor pressure to improve the drying process.

FIG. 4 depicts a block diagram of a device 400 to determine evaporation rate potential according to the disclosed embodiments. Device 400 may be a meter or other device that displays an ERP value to a user based on measurements taken in an environment 100 or inputted by the user. Preferably, device 400 is a hand held device.

Device 400 includes processor 402. Processor 402 performs the determinations for ERP values disclosed above. Processor 402 executes commands and instructions to calculate the determinations. Processor 402 may access memories 406 and 408 to retrieve the instructions. Memory 406, for example, may store the instructions for executions while memory 408 may store sets of conditions for determining ERP values. Alternatively, memory 408 may store ERP values, while memory 406 stores programs to operate device 400.

Device 400 also may include power supply 409 that provides power to the components, such as processor 402. Power supply 409 may include a battery, power from an adapter, and the like.

Device 400 also includes display 404. Display 404 displays the ERP values and conditions, if desired, to a user. Display 404 also may show instruction or recommendations for actions to be taken. Processor 402 may send instructions to display certain values in a known format.

Sensor 410 may sense or detect temperature in an environment surrounding device 400. Sensor 410 may take a series of measurements when commanded by processor 402 so that temperature readings are used for ERP determinations. Interface 414 encodes these measurements into a format understandable by processor 402 and forwards the values to it. The values also may be stored in memory 408 or 406.

Sensor 412 may sense or detect vapor pressure, or the grains per pound, of air 102 in environment 100. Interface 416 encodes the measurements to forward to processor 402. Preferably, interfaces 414 and 416 assign a value to the measurements in a format storable within memory 406 or memory 408, or readable by processor 402.

Another way to provide information to device 400 is via input 420. A user may enter values for the temperature, vapor pressure and the like to device 400 so that ERP values are determined even though specific measurements of the surrounding environment are not taken. Device 400 can take inputted data to provide ERP values so that a user can determine a course of action to take in improving drying conditions.

Thus, according to the disclosed embodiments, one can determine improved drying conditions with device 400 and take the appropriate action to ensure the improvements are made. Material 104 in an environment will not change, so the conditions need to be changed in order to improve drying. An environment with an ERP value of 100 will dry twice as fast as an environment with an ERP value of 50.

In other words, if 200,000 Btu/hr of energy of being introduced to a structure or system with 110 grains of moisture, every pound of water evaporated may take 1200 Btus of energy. This environment could potentially evaporate 167 lbs of water per hour provided the system accomplishes a 100% transfer of energy, which is not feasible. If the same 200,000 Btu/hr is applied to a structure with 30 grains of moisture, it would take approximately 800 Btus to evaporate each pound of water. Thus, with the same energy applied, a system could evaporate 250 lbs of water per hour provided that there is a 100% transfer of energy. Again, this percentage of transferring energy is not practical. This figure, however, shows a 50% increase in potential water removal capability.

Thus, a device and method to determine ERP values provides information to improve drying processes by assimilating information to compare and determine those conditions best suited for drying. Another way to improve drying performance is to heat material 104 being dried to increase the sub-gradient coming off material 104 in environment 100. For example, one may use infrared heat to heat material 104 so its temperature is as high as possible. Infrared heat transmits at a long wavelength and by passes the air 102 to directly heat the material 104. Using the heat may improve drying conditions along with the use of infrared heat.

It will be apparent to those skilled in the art that various modifications and variations can be made in the disclosed embodiments of the present invention without departing from the spirit or scope of the invention. Thus, it is intended that the present invention covers the modifications and variations of the embodiments disclosed above provided that they come within the scope of any claims and their equivalents.

What is claimed is:

1. A method for determining evaporation rate potential within an environment, the method comprising:
determining a sensible energy value;
determining a latent energy value, wherein the sensible energy value and the latent energy value comprise a total enthalpy value; and
determining an evaporation rate potential using a square value of the sensible energy value divided by the latent energy value.

2. The method of claim 1, wherein the first determining step includes using a temperature value to determine the sensible energy value.

3. The method of claim 1, wherein the second determining step includes using a vapor pressure value to determine the latent energy value.

4. The method of claim 1, wherein the environment includes air to provide the sensible energy value and the latent energy value.

5. The method of claim 1, wherein the environment includes a material to be dried.

6. The method of claim 1, further comprising displaying the evaporation rate potential.

7. The method of claim 2, further comprising sensing the temperature.

8. The method of claim 3, further comprising sensing the vapor pressure.

9. A method for improving drying within an environment, the method comprising:
determining a first evaporation rate potential for a first set of conditions;
determining a second evaporation rate potential for a second set of conditions;
determining a highest evaporation rate potential from the first evaporation rate potential and the second evaporation rate potential; and
indicating the highest evaporation rate potential.

10. The method of claim 9, further comprising performing an action to achieve the set of conditions corresponding to the highest evaporation rate potential.

11. The method of claim 9, further comprising displaying the first evaporation rate potential and the second evaporation rate potential.
